(19) United States
(12) Patent Application Publication
(10) Pub. No.: US 2011/0214522 A1
(43) Pub. Date: Sep. 8, 2011

(54) SHIFTING CLUTCH

(75) Inventors: Jan Sporleder, Ingelheim (DE); Joerg Appelshaeuser, Mainz (DE)

(73) Assignee: GM GLOBAL TECHNOLOGY OPERATIONS LLC, Detroit, MI (US)

(21) Appl. No.: 13/041,650

(22) Filed: Mar. 7, 2011

(30) Foreign Application Priority Data
Mar. 5, 2010 (DE) 102010010402.7

(51) Int. Cl. F16H 3/38

(52) U.S. Cl. 74/339

(57) ABSTRACT

A shifting clutch includes, but is not limited to a synchronizer body rotationally fixed on a shaft, a first and a second gear wheel, at least two synchronizing rings, a shifting sleeve which is displaceable over a neutral position on the synchronizer body in axial direction of the shaft between a first and a second shifted position, in which it establishes a non-positive connection between synchronizer body and the first or second gear wheel, and at least one thrust piece which is displaceable over a neutral position through the shifting sleeve between a first and a second synchronizing position, in which it loads the first or second synchronizing ring in each case against the first or second gear wheel. The shifting sleeve comprises at least one inwardly directed projection which in the first shifted position restricts the axial freedom of movement of the thrust piece.

### CROSS-REFERENCE TO RELATED APPLICATION

This application claims priority to German Patent Application No. 102010010402.7, filed Mar. 5, 2010, which is incorporated herein by reference in its entirety.

### TECHNICAL FIELD

The technical field relates to a shifting clutch for a stepped transmission, particularly in a motor vehicle.

### BACKGROUND

Conventionally, a shifting clutch comprises a synchronizer body, a gear wheel, at least one synchronizing ring, a shifting sleeve which can be shifted on the synchronizer body in axial direction of the shaft between a neutral position and a shifted position, in which it establishes a non-positive connection between the synchronizer body and the gear wheel, and at least one thrust piece, which can be displaced by the shifting sleeve from a neutral position into a synchronizing position, in which it loads the synchronizing ring against the gear wheel in order to adjust the rotational speed of the gear wheel to that of the shaft.

Shifting clutches with two gear wheels and at least two synchronizing rings are also widely distributed. The shifting sleeve can be displaced from the neutral position in opposite directions into a first or a second shifted position in order to establish the non-positive connection between the synchronizer body and the first or the second gear wheel.

FIG. 1 shows a schematic axial section through such a shifting clutch. The synchronizer body 2 mounted to the shaft 1 in a rotationally fixed manner is shaped similar to a gear. An outer gear rim 12 of the synchronizer body is interrupted at several points by cutouts, each of which receive a thrust piece 13. The sectional plane of FIG. 1 runs through such a cutout and the thrust piece 13 received therein. A rigid basic body 14 of the thrust piece 13 comprises a hollow shaft 15 in which a coil spring 16 is accommodated, and a head 17 widened with respect to the shaft 15, which receives a ball 18 loaded by the coil spring 16 radially to the outside. Teeth of the synchronizer body 2 shown in FIG. 1 as interrupted line contours since located outside the sectional plane are in engagement with shifting claws 3 of a shifting sleeve 4 directed radially to the inside, which shifting sleeve surrounds the synchronizer body 2 and the thrust pieces 13 in the form of a ring. The shifting sleeve 4 on its outside comprises a circumferential groove in which a shifting fork that is not shown engages in order to displace the shifting sleeve 4 driven by a shift/selector lever provided in the passenger cell of a motor vehicle or a linear actuator which is not shown in axial direction.

At least those shifting claws 3 of the shifting sleeve 4 located opposite a thrust piece 13 comprise a central clearance 20 in which the ball 18 engages when the shifting sleeve 4 is in its neutral position. This engagement causes the thrust piece 13 to be driven when the shifting fork deflects the shifting sleeve 4 sideways, in the direction of one of the two flanking gear wheels 5, 6. In the process, the head 17 of the thrust piece 13 strikes one of the two adjacent synchronizing rings 7, 8, pressing it against a friction cone 9 for example of gear wheel 5. A hook 21 of the synchronizing ring 8 engages in the clearance of the synchronizer body 2 with rotary clearance so that the synchronizing ring 7 is driven by the rotation of the synchronizer body 2. The rotary clearance of the synchronizing ring 7 is dimensioned so that at that stage an offset between teeth 22 of the synchronizing ring 7 and teeth 23 of a shift toothing of the gear wheel 5 blocks further advancing of the shifting sleeve 4. After completed synchronization of the gear wheel 5 with the shaft 1 a rotation of the synchronizing ring 7 relative to the gear wheel becomes possible again and the shifting sleeve 4 advances in the shifted position shown in FIG. 1, in which its shifting claws 3 engage in the shift toothing of the gear wheel 5 and the gear wheel 5 is coupled to the shaft 1 in a fixed manner.

In order to be able to control shifting operations simply and with large tolerance with given dimensions of a transmission it is desirable to make an axial freedom of movement of the shifting sleeve 4 as large as possible. Conversely, it is also desirable with given freedom of movement of the shifting sleeve to be able to make the spacing between gear wheels flanking said shifting sleeve as small as possible in order to obtain a compact transmission on the whole.

Enlarged freedom of movement of the shifting sleeve with given dimensions of the shifting clutch can be realized in that the axial expansion of the shifting sleeve 4 is reduced, as indicated by an interrupted outline in FIG. 1. However, this results in the problem that when in one of the shifted positions the ball 18 of the thrust piece 13 comes too closely to a face end of the shifting sleeve 4 the ball 18 tends to yield obliquely to the outside, as is indicated by an arrow 24 in FIG. 1. In the process, the head 17 of the thrust piece 13 can strike the second synchronizing ring 8, which consequently rubs against the friction cone 10 of the gear wheel 6. The consequence of this is a premature wear of the shifting clutch. A further consequence is the blocking in the shifted gear, when the shifting sleeve 4 is to be shifted back into the neutral position, the ball 18 against the force of the spring 16 has to be first forced out of the intermediate space between the shifting sleeve 4 and the synchronizing ring 8.

In view of the foregoing, at least one object is to create a shifting clutch, which with compact dimensions, guarantees a large freedom of movement of the shifting sleeve and prevents premature friction wear or blocking in the shifted gear at the same time. In addition, other objects, desirable features and characteristics will become apparent from the subsequent detailed description, and the appended claims, taken in conjunction with the accompanying drawings and this background.

### SUMMARY

The object is solved in that with a shifting clutch with a rotationally fixed synchronizer body on a shaft, a first and a second gear wheel, at least two synchronizing rings, a shifting sleeve which on the synchronizer body can be displaced over a neutral position between a first and a second shifted position in which it establishes a non-positive connection between synchronizer body and the first or second gear wheel and at least one thrust piece which through the shifting sleeve between a first and a second synchronizing position, in which it loads the first or second synchronizing ring respectively against the first or second gear wheel respectively, is displaceable over a neutral position, the shifting sleeve comprises a projection directed inwardly, which in the first shifted position restricts the axial freedom of movement of the thrust piece. Such a projection can reliably prevent the yielding movement of the thrust piece 13 even with low axial dimensions of the shifting sleeve 4.

The freedom of movement of the thrust piece in the first shifted position is restricted through the first projection practically to an interval between the neutral position and the first synchronizing position. The neutral position itself need not be part of the interval, i.e. when the shifting sleeve is in the first shifted position the thrust piece cannot return into its neutral position. That the thrust piece because of this possibly maintains a constant pressure on the first synchronizing ring in the first shifted position is harmless, since said synchronizing ring does not rotate relative to the first gear wheel and consequently no friction wear occurs between the two. If the interval does not include the neutral position the shifting sleeve—and with it the entire shifting clutch—can be constructed particularly narrowly with given axial freedom of movement.

According to a first embodiment, the projection limits a second clearance of the shifting sleeve in which the engagement tip engages in the first shifted position. According to an alternative embodiment, an axially oriented sliding flank, along which the thrust piece slides during shifting, extends from the central clearance of the shifting sleeve as far as to the projection. According to a further embodiment, a sliding flank is provided which extends from the central clearance of the shifting sleeve as far as to the projection in axial direction and radially to the outside.

### BRIEF DESCRIPTION OF THE DRAWINGS

The present invention will hereinafter be described in conjunction with the following drawing figures, wherein like numerals denote like elements, and

FIG. 1 already discussed, a schematic section through a conventional shifting clutch;

FIG. 2 a section through a shifting clutch according to a first embodiment of the invention;

FIG. 3 a perspective view of a shifting claw according to the first embodiment;

FIG. 4 a section through a second embodiment of the shifting clutch;

FIG. 5 a perspective view of a shifting claw according to the second embodiment;

FIG. 6 a section through a third embodiment of the shifting clutch; and

FIG. 7 a perspective view of a shifting claw according to the third embodiment.

### DETAILED DESCRIPTION

The following detailed description is merely exemplary in nature and is not intended to limit application and uses. Furthermore, there is no intention to be bound by any theory presented in the preceding background or summary or the following detailed description.

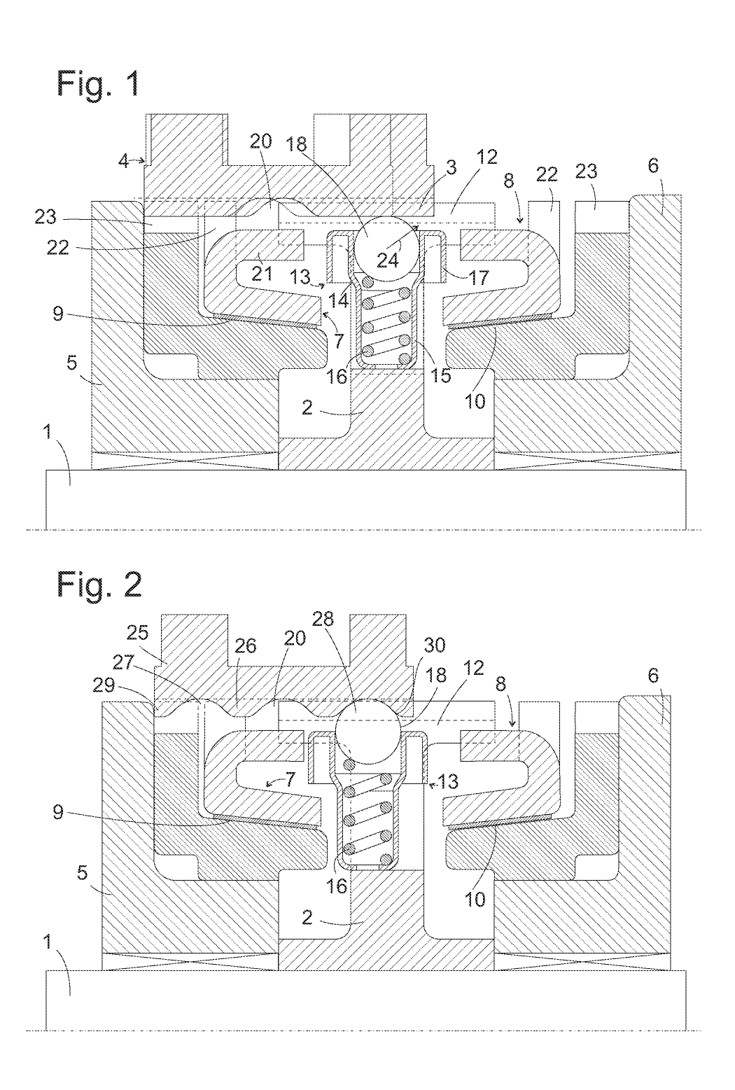

FIG. 2 shows a section through a shifting clutch according to an embodiment of the invention similar to FIG. 1. The shaft 1, the synchronizer body 2, the gear wheels 5, 6 and synchronizing rings 7, 8 correspond to those of FIG. 1 and are not described again. The shifting sleeve 25 surrounding the synchronizer body 2 in the shape of a ring has three shifting claws 26 each facing one of the three thrust pieces 13 which on both sides of the central clearance 20, in which the thrust piece 13 engages, when the shifting sleeve 25 is in its neutral position, there are additional clearances 27, 28. The clearances 27, 28, as shown here, can be congruent with the central clearance 20, but they can also have a lower depth than the central clearance 20 in order to realize an engagement of the ball 18 in the shifted position of the shifting sleeve 25 that is easier to release than in the neutral position. Projections 29, 30 that delimit the clearances 27, 28 towards the face ends of the shifting sleeve 25 render yielding of the thrust piece 13 in the direction of the gear wheel that is not shifted in each case impossible as described with reference to FIG. 1. The projections 29, 30 are rather arranged such that if one of these, in the case of FIG. 2 the projection 30, touches the ball 18 the thrust piece 13 as a result is deflected in the direction of the respective shifted gear wheel, in this case gear wheel 5. This allows additionally reducing the spacing between the synchronizing rings 7, 8 and consequently also that between the gear wheels 5, 6.

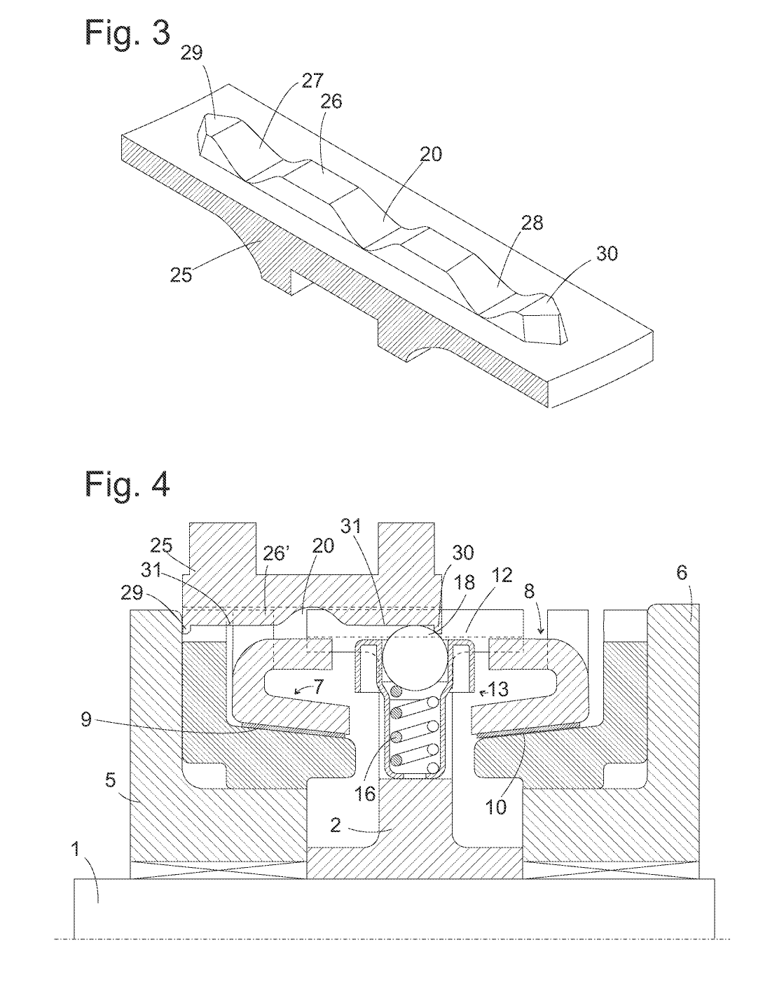

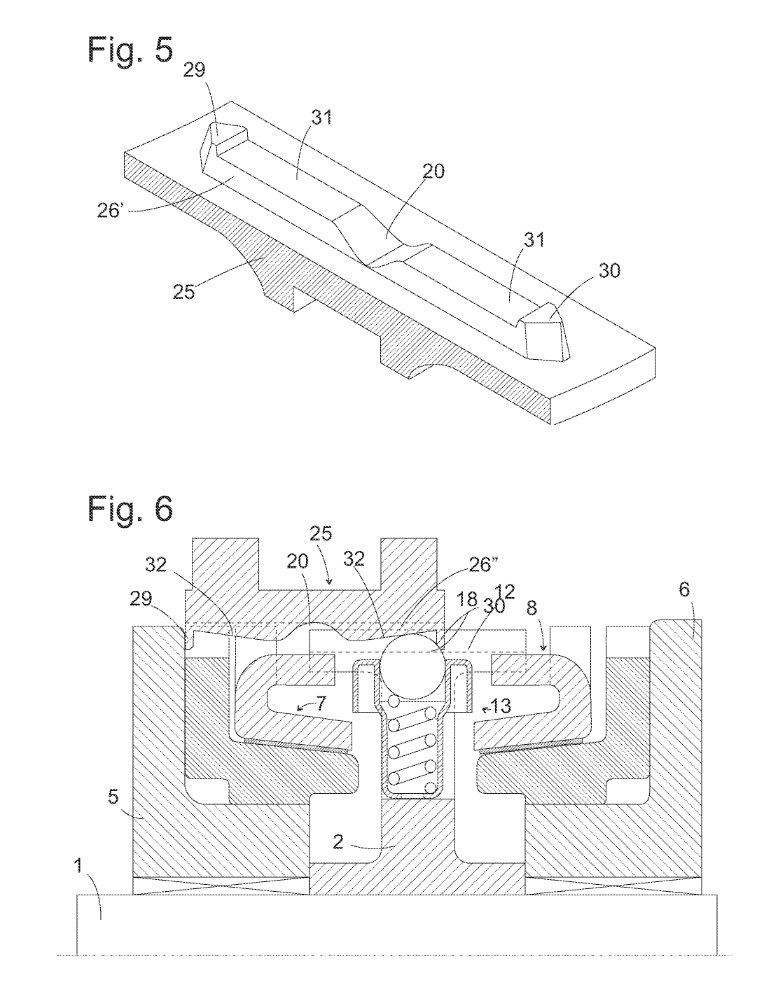

FIG. 3 shows the shifting claw 26 interacting with the thrust piece 13 in a perspective view. A side effect of the additional clearances 27, 28 is that when the synchronization for example of the gear wheel 5 with the shaft 1 is completed and the synchronizing ring 7 of the shifting sleeve 25 opens the way into the first shifted position shown in FIG. 2, the spring 16 of the thrust piece 13 drives this advancing movement. Conversely, for disengaging the shifting sleeve 25 from the shifted position, a resistance of the spring 16 has to be overcome initially. If this is not desirable, instead of the shifting claw 26 with the three clearances 20, 27, 28 of FIGS. 2 and 3, a shifting claw 26′ of the type shown in FIGS. 4 and 5 can be used, wherein the central clearance 20 on both sides is surrounded by axially oriented sliding flanks 31 and the projections 29, 30 radially directed inwardly each form terminations of the sliding flanks 31.

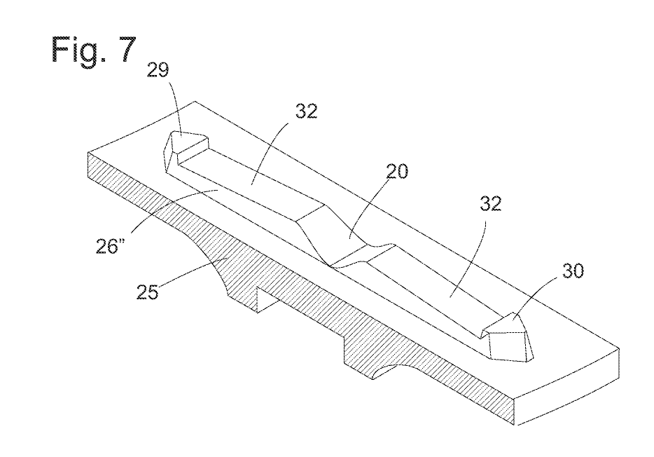

With the third embodiment shown in FIGS. 6 and 7, the axially oriented sliding flanks 31 are replaced with sliding flanks 32 extending linearly to the outside from the central clearance 20. The projections 29, 30 in this case need not project further radially to the inside than the regions of the sliding flank 32 immediately adjacent to the clearance 20. This allows reducing the radial expansion of the shifting claws compared with the second configuration without having to reduce the depth of the central clearance 20 return that is without having to accept cuts in terms of strength of the engagement of the ball 18 in the clearance 20. For this reason, the diameter of the shifting sleeve 25 in this case can be made smaller than with the second configuration. In addition to this, the oblique orientation of the sliding flanks 32 ensures that in the shifted position of the shifting sleeve 25 the synchronizer bodies 2 in each case assume a clearly determined position, in which their ball 18 bears against one of the projections 29 or 30. Since the steepness of the sliding flanks 32 is substantially lower than for example that of the inner flanks of the clearances 27, 28 of the first configuration, their oblique orientation does not impede the disengaging of a shifted gear.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A shifting clutch, comprising:
a shaft;
a synchronizer body rotationally fixed on the shaft;
a first gear wheel;
a second gear wheel;
a first synchronizing ring and a second synchronizing ring;
a shifting sleeve on the synchronizer body in axial direction of the shaft between a first shifted position and a second shifted position that establishes a non-positive connection between the synchronizer body and the first gear wheel or the second gear wheel is displaceable over a neutral position, and a thrust piece is displaceable over the neutral position through the shifting sleeve between a first synchronizing position and a second synchronizing position in which in each case loads the first synchronizing ring or the second synchronizing ring against the first gear wheel or the second gear wheel,
wherein the shifting sleeve comprises a projection directed inwardly that in the first shifted position restricts an axial freedom of movement of the thrust piece.

2. The shifting clutch according to claim 1, wherein the projection in the first shifted position restricts a freedom of movement of the thrust piece to an interval between the neutral position and the first synchronizing position.

3. The shifting clutch according to claim 2, wherein the interval does excludes the neutral position.

4. The shifting clutch according to claim 1, wherein the thrust piece comprises a main body that is rotationally fixed with respect to the synchronizer body and axially moveable between the first synchronizing position and the second synchronizing position and comprises a spring-loaded engagement tip radially moveable against the main body.

5. The shifting clutch according to claim 4, wherein the shifting sleeve comprises a central clearance in which an engagement tip in the neutral position and synchronizing positions positively engages.

6. The shifting clutch according to claim 5, wherein the projection delimits a second clearance of the shifting sleeve in which the engagement tip engages in the first shifted position.

7. The shifting clutch according to claim 5, wherein an axially oriented sliding flank extends from the central clearance of the shifting sleeve as far as to the projection.

8. The shifting clutch according to claim 5, wherein a sliding flank extends from a radial clearance of the shifting sleeve in axial direction and radially to the outside as far as to the projection.
